(19) United States
(12) Patent Application Publication
(10) Pub. No.: US 2015/0019014 A1
(43) Pub. Date: Jan. 15, 2015

(54) DEVICE AND METHOD FOR QUALITY INSPECTION OF AUTOMOTIVE PART

(71) Applicant: Hyundai Motor Company, Seoul (KR)

(72) Inventor: Tae Ho Kim, Seoul (KR)

(73) Assignee: Hyundai Motor Company, Seoul (KR)

(21) Appl. No.: 14/106,632

(22) Filed: Dec. 13, 2013

(30) Foreign Application Priority Data
Jul. 11, 2013 (KR) 10-2013-0081600

(51) Int. Cl. B25J 9/16; G06T 7/00

(52) U.S. Cl. CPC B25J 9/1697; G06T 7/0004; Y10S 901/47
USPC 700/259; 901/47

(57) ABSTRACT

A device for quality inspection of an automotive part includes i) a jig unit for securing and supporting an inspection object, ii) rotary vision imager mounted to a fore end of a robot arm rotatable in a turret type for vision photographing a plurality of processed portions of the inspection object, and iii) a controller for obtaining a vision data from the rotary vision imager, and analyzing and processing the vision data for extracting a defect of the processed portion.

### CROSS-REFERENCE TO RELATED APPLICATION

The present application claims priority of Korean Patent Application Number 10-2013-0081600 filed Jul. 11, 2013, the entire contents of which application is incorporated herein for all purposes by this reference.

### BACKGROUND OF INVENTION

1. Field of Invention

The present invention relates to a device for quality inspection of an automotive part. More particularly, the present invention relate to device and method for quality inspection of an automotive part which enables automatic vision examination of major processed portions of a transmission case having a three dimensional complicated shape.

2. Description of Related Art

In general, in a manufacturing line of the transmission which is a major part of a vehicle, different major components of the transmission, such as a transmission case, shafts, gears, friction elements, and so on are processed and fabricated. Of the components, the transmission case has major components of the transmission and a valve body cover mounted thereon.

The transmission case has processed portions, such as mounting surfaces on upper and lower sides and inside and outside thereof, oil holes, and bores, formed by casting and machining.

In the meantime, the transmission manufacturing line accompanies an inspection process for inspecting a quality of each processed articles of the transmission. In the inspection process, defects, damages, and omission of processing on processed portions of the transmission case are inspected with naked eyes of a worker.

However, in such a quality inspection process, there has been difficulty in the naked eye inspection of the worker due to the three dimensional complicated shape of the transmission case, and the quality inspection process requires at least two inspecting members, and is liable to have outflow of defective components taken place therefrom because the quality inspection process relies on subjective determination of the workers.

Such outflow of the defective component may cause leakage of oil come from the defect of the processed portion of the transmission case, which may cause malfunction of shifting of the transmission, and contamination of the transmission.

Recently, by vision photographing of the processed portion of the transmission case with a vision head, and analyzing and processing a vision data thereof, the defects, the damages, and the omission of processing of the transmission case are inspected automatically.

However, if the processed portion of the transmission case is vision examined by using the vision head automatically, it is impossible to make perfect inspection of the different processed portions only with one set of the vision head because the transmission case has a three dimensionally complicated shape.

Consequently, though the different processed portions of the three dimensionally complicated transmission case may be subjected to the vision inspection by using a plurality of robots each having the vision head mounted thereto, the vision examination may cause an increased initial investment coming from an increased number of the robots and an installation space of inspection equipment to be secured, and an increased cycle time of the quality inspection.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention provide for a device and method for quality inspection of an automotive part which enables automatic vision examination of different processed portions of an inspection object having a three dimensional complicated shape by using a multi-vision head.

Various aspects of the present invention provide for a device for quality inspection of an automotive part that may include i) a jig unit for securing and supporting an inspection object, ii) rotary vision photographing means mounted to a fore end of a robot arm to be rotatable in a turret type for vision photographing a plurality of processed portions of the inspection object, and iii) a controller for obtaining a vision data from the rotary vision photographing means, and analyzing and processing the vision data for extracting a defect of the processed portion.

The rotary vision photographing means may include a circular turret body mounted to a fore end of the robot arm with a mounting bracket to be rotatable in both directions for a predetermined section by a step motor, and a plurality of vision heads mounted to the turret body radially for vision photographing the processed portions of the inspection object.

The vision heads may vision photograph the inside/outside mounting surfaces, the inside surface of the hole, and the inside surface of the bore of the inspection object with the turret body rotated at a fixed angle by the step motor.

The plurality vision heads mounted to the turret body spaced from one another at fixed angles may include a first vision head for vision examination of the inside/outside mounting surfaces of the inspection object, a second vision head for vision examination of the inside surface of the hole of the inspection object, and a third vision head for vision examination of the inside surface of the inspection object.

Each of the vision heads may include a camera unit for vision photographing the processed portion of the inspection object, and a lighting unit for directing a light to an inspection portion.

The jig unit may include a base frame, a rotary table rotatably mounted to the base frame, a plurality of jig frames mounted on the rotary table to stand upright, fixing members mounted to some of the jig frames for securing the inspection object, and supporting members mounted to rest of the jig frames for supporting the inspection object.

The base frame may have a square shape matched to the rotary table.

The base frame may also have a rotation shaft mounted at a central portion of the base frame for coupling to the rotary table.

The base frame may also have a plurality of roller members mounted thereto radially to be rotatable centered on the rotation shaft.

The rotary table may have a restriction roller rotatably mounted to each of corners of the rotary table.

The base frame may have a restriction stopper mounted to each of corner portions of the base frame matched to the restriction roller for supporting the restriction roller elastically and restricting a rotation position of the rotary table.

The stopper may include a fixed block mounted fixedly secured to each of the corner portions of the base frame, a restriction block having a holding recess for holding a roller surface of the restriction roller, the restriction block being movably mounted to the fixed block with one pair of guide rods passed through the fixed block, a supporting block mounted to a passed through end portion of the guide rods, and a spring disposed between the restriction block and the fixed block for applying elastic force to the restriction block.

The supporting block may have an adjusting knob screw coupled thereto for adjusting the elastic force of the spring.

The fixing member may include a first securing pin mounted to the jig frame for coupling to a securing hole in the inspection object from a lower side to an upper side of the securing hole.

The fixing member may include a second securing pin mounted to the jig frame for coupling to a securing hole in the inspection object from an upper side to a lower side of the securing hole.

The second securing pin may be provided to a securing bracket which may be secured to a top side portion of the jig frame for coupling to the securing hole passed through the top side portion.

The supporting member may be mounted to the jig frame and may include a supporting pin for supporting an underside of the inspection object.

The supporting member may be mounted to the jig frame and may include a supporting surface for supporting an underside of the inspection object.

The jig unit may further include at least one hand grip member foldably mounted to an upper surface of the rotary table.

Various aspects of the present invention provide for a device for quality inspection of an automotive part that may include i) a jig unit for securing and supporting an inspection object including a transmission case, ii) a circular turret body mounted to a fore end of a robot arm with a mounting bracket, the turret body being provided to be rotatable a predetermined section in both directions by a step motor, iii) a plurality of vision heads mounted to the turret body radially for vision photographing the processed portion of the inspection object, and iv) a controller for obtaining a vision data from the vision head and analyzing and processing the vision head for extracting a defect from the processed portion.

Various aspects of the present invention provide for a method for quality inspection of an automotive part, in which processed portions of an inspection object including a transmission case is vision examined, that may include the steps of (a) providing the device for quality inspection of an automotive part of claim 17, (b) setting the inspection object to the jig unit, and mounting a turret body to a fore end of a robot arm, (c) driving a step motor to rotate the turret body, and moving one of a plurality of vision heads toward an inside/outside processed portion of the inspection object, (d) photographing the processed portion with the vision head and forwarding a vision data photographed thus to a controller, and (e) analyzing and processing the vision data with the controller for extracting defect data on the processed portion.

And, the method for quality inspection of an automotive part may further include the steps of rotating a rotary table of the jig unit at 90 degree intervals, rotating the vision heads at fixed angles with the turret body, and vision examining inside/outside mounting surfaces, an inside surface of a hole, and an inside surface of a bore of the inspection object.

And, a rotation position of the rotary table may be restricted by a stopper.

And, the defect data extracted by the controller and whether the processed portion of the inspection object has a defect or not may be displayed on display means.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a schematic view showing an exemplary device for quality inspection of an automotive part in accordance with the present invention.

FIG. 2 illustrates a perspective view of a jig unit of an exemplary device for quality inspection of an automotive part in accordance with the present invention.

FIG. 3 illustrates a perspective view of a stopper in a jig unit of an exemplary device for quality inspection of an automotive part in accordance with the present invention.

FIG. 4, FIG. 5 and FIG. 6 illustrate perspective views each showing a turret type multi-vision head of an exemplary device for quality inspection of an automotive part in accordance with the present invention.

FIG. 7A, FIG. 7B and FIG. 7C illustrate perspective views for describing operation of an exemplary device for quality inspection of an automotive part in accordance with the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

In order to describe the present invention clearly, parts not related to description of the present invention will be omitted, and identical or similar elements will be given the same reference symbols throughout the specification.

As a size and a thickness of an element in the drawings are shown at will for convenience of description, the present invention is not limited to ones shown in the drawings without fail, and the thicknesses are enlarged for expressing many portions and regions, clearly.

And, though terms including ordinal numbers, such as first or second, can be used for describing various elements in the detailed description of the present invention, for making one element distinctive from other elements, the elements are not confined by an order of the terms without fail in the following description.

In addition, throughout the specification, unless explicitly described to the contrary, the word “comprise” and variations such as “comprises” or “comprising”, will be understood to imply the inclusion of stated elements but not the exclusion of any other elements.

And, a term, such as “ . . . unit”, “ . . . means”, “ . . . unit”, “ . . . member”, or so on in the specification means a unit of a collective element which makes at least one function of operation.

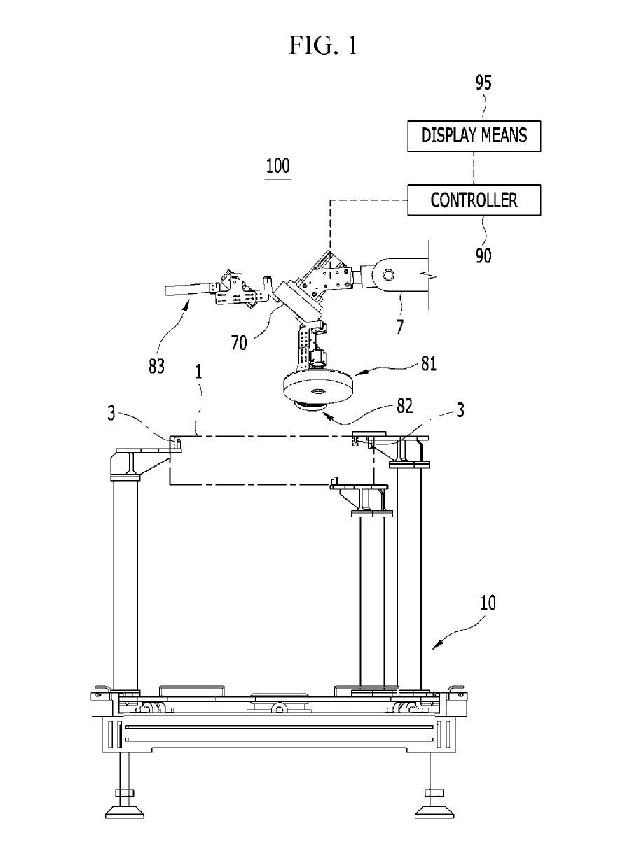

FIG. 1 illustrates a schematic view showing a device for quality inspection of an automotive part in accordance with various embodiments of the present invention.

Referring to FIG. 1, the device 100 for quality inspection of an automotive part in accordance with various embodiments of the present invention may be applied to a transmission manufacturing line in which major components of the transmission are processed and assembled.

For an example, in the transmission manufacturing line, a transmission case having a three dimensionally complicated shape is fabricated, and the transmission case, the major components of the transmission, and a valve body cover are assembled, together.

In the transmission manufacturing line, an inspection process is carried out for quality inspection of such processed articles, wherein the device 100 for quality inspection of an automotive part in accordance with various embodiments of the present invention inspects the transmission case as an inspection object 1 for defects, damages, and omissions of processing.

That is, the device 100 for quality inspection of an automotive part in accordance with various embodiments of the present invention may subject different processed portions of an inside surface and outside surface of the inspection object 1, such as mounting surfaces (Processed surfaces) on the outside and inside, an inside surface of a hole, and an inside surface of a bore of the inspection object 1, to vision examination.

The device 100 for quality inspection of an automotive part in accordance with various embodiments of the present invention has a structure which may subject the different portions of the inspection object 1 having a three dimensional complicate shape to automatic inspection by using one set of robot in a multi-vision head mode.

For this, basically, the device 100 for quality inspection of an automotive part in accordance with various embodiments of the present invention includes a jig unit 10, a turret body 70, rotary vision photographing means, or other suitable rotary vision imager, including a plurality of multi-vision heads 81, 82, and 83, and a controller 90.

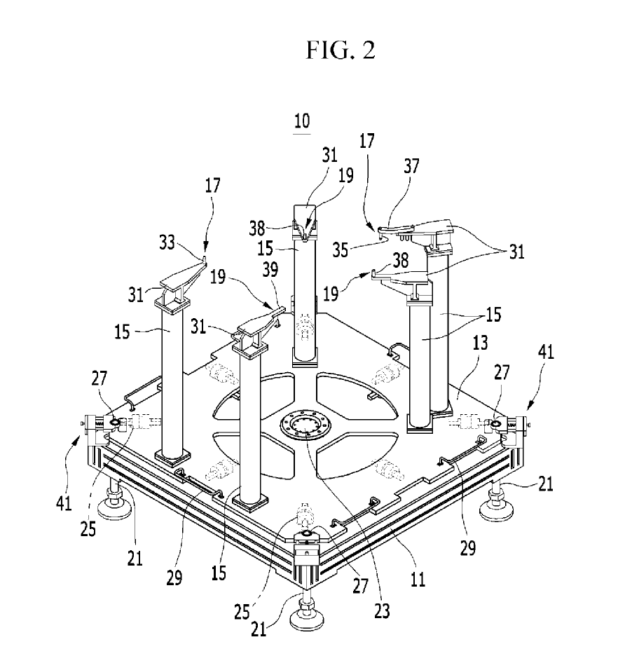

FIG. 2 illustrates a perspective view of a jig unit of a device for quality inspection of an automotive part in accordance with various embodiments of the present invention.

Referring to FIGS. 1 and 2, in various embodiments of the present invention, the jig unit 10, for securing and supporting the inspection object 1 (See FIG. 1), includes a base frame 11, a rotary table 13, jig frames 15, fixing members 17, and supporting members 19.

The base frame 11 is installed on a floor of a working site where the inspection process of the inspection object 1 is made. The base frame 11 has a square frame shape and supporting legs 21 at corners of an underside thereof, respectively.

And, mounted at a central portion of the base frame 11, there is a rotation shaft 23 coupled to the rotary table 13 to be described in more detail, later. And, the base frame 11 has a plurality of roller members 25 rotatably mounted thereto radially centered on the rotation shaft 23.

In this case, the roller members 25 are rollers rolling in contact with an underside of the rotary table 13 for supporting rotation of the rotary table 13.

In above description, the rotary table 13, rotatable in both directions on an upper surface of the base frame 11, has a square shape matched to the base frame 11 and is coupled to the rotation shaft 23 of the base frame 11.

That is, the central portion of the rotary table 13 has the rotation shaft 23 coupled thereto, and, as described before, the underside thereof is in rolling contact with the roller members 25.

In this case, rotatably mounted to an upper side of each of the corner portions of the rotary table 13, there is a restriction roller 27 for restricting a rotation angle of the rotary table 13.

And, mounted to upper side edge portions of the rotary table 13, there are a plurality of hand grip members 29 for manual rotation of the rotary table 13.

The hand grip member 29 has a “ [symbol] ” shape for enabling an inspection worker to grip, and both ends thereof coupled to the upper side of the rotary table 13 mounted foldable to the upper side of the rotary table 13.

The jig frames 15 are vertical frames standing upright on the upper side of the rotary table 13 for supporting the inspection object 1, actually.

From an example, the jig frames 15 may be five in number thereof mounted on the upper side of the rotary table 13. Of the five jig frames 15, four jig frames 15 may be mounted to corner side portions of the rotary table 13 substantially, and rest one thereof may be mounted to one of the corner side portions.

A supporting bracket 31 is mounted to a top end of each of the jig frames 15 for mounting a fixing member 17 and a supporting member 19 to be described later thereto.

The fixing member 17, for securing the inspection object 1 actually, may be provided to each of two jig frames 15 symmetry to each other mounted to the corner portions of the rotary table 13 as members of the jig frames 15.

One of the fixing members 17 includes a first securing pin 33 mounted thereto. The first securing pin 33 may be mounted to the supporting bracket 31 at the top side portion of the jig frame 15 in a vertical direction for coupling to a securing hole 3 (See FIG. 1) in the inspection object 1 from a lower side to an upper side of the securing hole 3.

And, the other one of the two jig frames 15 includes a second securing pin 35 mounted thereto. The second securing pin 35 may be mounted to the supporting bracket 31 at the top side portion of the jig frame 15 in the vertical direction for coupling to another securing hole 3 (See FIG. 1) in the inspection object 1 from an upper side to a lower side of the securing hole 3.

In this case, the second securing pin 35 may be mounted to a securing bracket 37 securable to the supporting bracket 31 at the top side portion of the jig frame 15.

Of the five jig frames 15, the supporting members 19, for supporting an underside of the inspection object 1 actually, may be provided to three jig frames 15 excluding the jig frames 15 having the fixing members 17 mounted thereto, respectively.

The supporting members 19 include supporting pins 38 mounted to two jig frames 15 out of the three jig frames 15, respectively. The supporting pin 38, for supporting an underside corner portion of the inspection object 1, is mounted to the supporting bracket 31 at the top side portion of the jig frame 15 in the vertical direction.

And, the supporting member 19 mounted to the rest one of the three jig frames 15 includes a supporting surface 39. The supporting surface 39, for seating an underside corner portion of the inspection object 1, is provided as an upper surface of a block fixedly secured to the supporting bracket 31 at the top side portion of the jig frame 15.

In the meantime, in various embodiments of the present invention, mounted to each corner portion of the base frame 11 matched to each of the restriction roller 27 of the rotary table 13 described before, there is a stopper 41 for supporting the restriction roller 27 elastically and restricting a rotation position of the rotary table 13, actually.

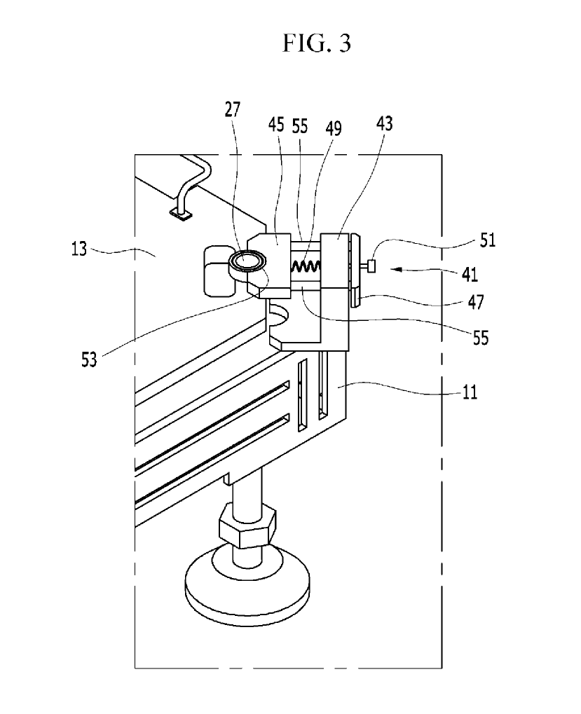

Referring to FIG. 3, the stopper 41 in accordance with various embodiments of the present invention includes a fixed block 43, a restriction block 45, a supporting block 47, a spring 49, and adjusting knob 51.

The fixed block 43 is mounted fixedly secured to each of the corner portions of the base frame 11. The restriction block 45 having a holding recess 53 for holding a roller surface of the restriction roller 27 is movably mounted to the fixed block 43 with one pair of guide rods 55 passed through the fixed block 43.

The supporting block 47 is mounted to a passed through end portion of the guide rods 55 passed through the fixed block 43. The spring 49 is disposed between the restriction block 45 and the fixed block 43 for applying elastic force to the restriction block 45.

And, the adjusting knob 51, for adjusting the elastic force of the spring 49, is screw coupled to the supporting block 47. The adjusting knob 51 is screw coupled to the supporting block 47 mounted to the fixed block 43 to be rotatable, freely.

On the other hand, in various embodiments of the present invention, the rotary vision photographing means is mounted to a fore end of an arm of an articulated robot 7 (See FIG. 1), and has a function of vision photographing a plurality of processed portions of the inspection object 1 while rotating like a turret.

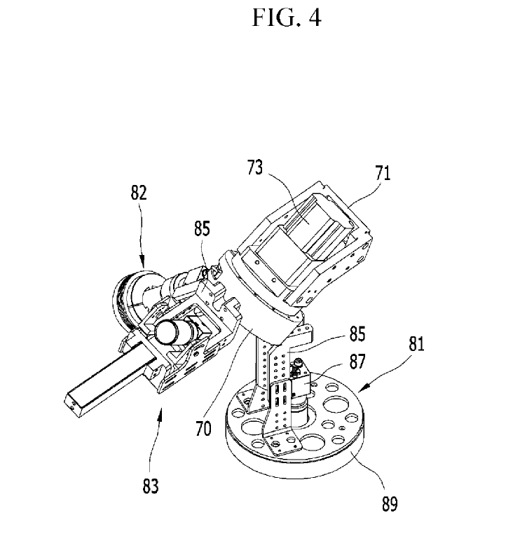

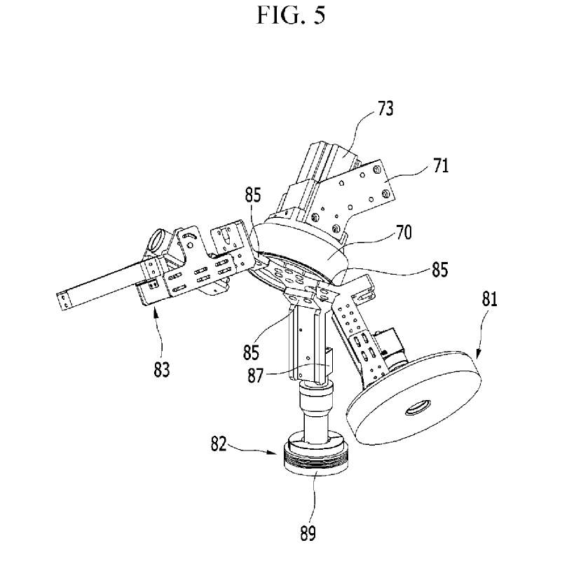

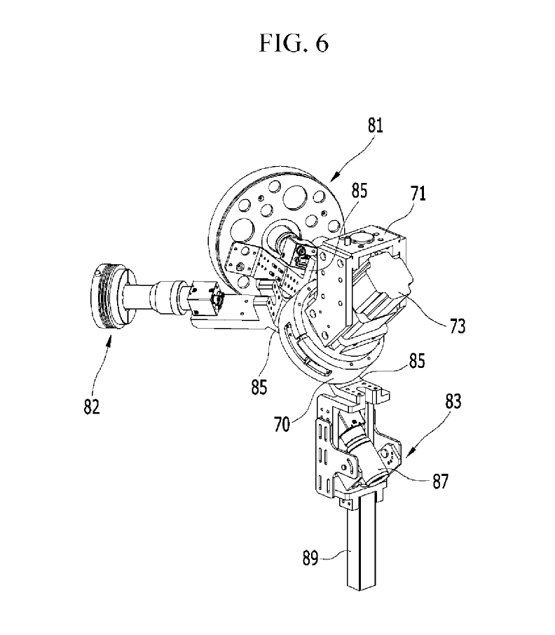

As described before, the rotary vision photographing means is a turret type multi-vision head including the turret body 70, and a plurality of vision heads 81, 82, and 83. The turret type multi-vision head is illustrated in FIGS. 4 to 6.

Referring to FIGS. 4 to 6, in various embodiments of the present invention, the turret body 70 is mounted to the fore end of the arm of the robot 7 with the mounting bracket 71 so as rotatable for a fixed section in both directions by a step motor 73.

The mounting bracket 71 may have a tool changer coupled to the arm of the robot 7.

And, the step motor 73 makes one rotation at 200 pulses for enabling free rotation to a desired angle, and rotation thereof can be controlled to rotate at 1.8 degrees in one step. The step motor 73 has a rotor rotated by rotation of magnetic poles of a stator as the rotor is attracted and repulsed by electro-magnetic force superimposed at the stator coil.

Since the step motor 73 is known to this field of art, detailed description of the step motor 73 will be omitted from the specification.

In this case, the turret body 70 is a circular body coupled to a driving shaft of the step motor 73 for rotating at a fixed angle by the step motor 73.

In various embodiments of the present invention, the vision heads 81, 82, and 83 are provided for vision photographing the different processed portions (Portions to be inspected) of the inspection object 1 loaded on the jig unit 10.

The vision heads 81, 82, and 83 are mounted to the turret body 70 at fixed angles with the connection brackets 85 radially, respectively.

In this case, the vision heads 81, 82, and 83 may vision photograph inside/outside mounting surfaces (Processed surfaces), an inside surface of a hole, and an inside surface of a bore of the inspection object 1 while rotated by the turret body 70 which is rotated at the fixed angle by the step motor 73.

In various embodiments of the present invention, the vision heads 81, 82, and 83 may be a first vision head 81 for vision examination of the inside/outside mounting surfaces of the inspection object 1, a second vision head 82 for vision examination of the inside surface of the hole of the inspection object 1, and a third vision head 83 for vision examination of the inside surface of the bore of the inspection object 1.

Each of the first to third vision heads 81, 82, and 83 has an optical system including a camera unit 87 for vision photographing the processed portion of the inspection object 1, and a lighting unit 89 for directing a light to the processed portion.

Since the camera unit 87 and the lighting unit 89 of each of the vision heads 81, 82, and 83 are a 2D camera and an LED lighting known in this field of art respectively, more detailed description of which will be omitted from the specification.

In various embodiments of the present invention, though an example is described, in which the vision heads 81, 82, and 83 mounted to the turret body 70 radially are three in number thereof, but a number of the heads are not limited to three, and four or more than four vision heads may be provided depending on a size of the turret body 70.

In the meantime, the controller 90 in FIG. 1 controls general operation of the device 100, and obtains vision data from the cameras 87 of the vision heads 81, 82, and 83, analyzes and processes the data, for extracting a defect from the processed portion (Inspected portion).

That is, the controller 90 may compare and analyze the vision data obtained by the camera units 87 of the vision heads 81, 82, and 83 to a reference data to extract the defect data on the processed portion of the inspection object 1.

In this case, the controller 90 may also display the defect data on the processed portion of the inspection object 1, and whether the inspection object 1 is defective or not with reference to the defect data on display means 95.

Hereafter, a method for quality inspection of an automotive part by using the device 100 for quality inspection of an automotive part in accordance with various embodiments of the present invention will be described with reference to the drawings disclosed before and accompanying drawings, in detail.

Referring to FIG. 1, in various embodiments of the present invention, the transmission case is loaded on the jig unit 10 as the inspection object 1.

In this case, the inspection object 1 may be loaded on the jig frames 15 from the rotary table 13 of the jig unit 10 with the fixing members 17 and the supporting members 19 of the jig frames 15.

In this case, the inspection object 1 may be secured to the jig frames 15 as the first securing pin 33 at the fixing member 17 is coupled to the securing hole 3 in the inspection object 1 from the lower side to the upper side of securing hole 3, and the second securing pin 35 is coupled to another securing hole 3 in the inspection object 1 from the upper side to the lower side of the securing hole 3.

And, the inspection object 1 may be supported on the jig frames 15 as the supporting pins 38 of the supporting members 19 support underside corner portions of the inspection object 1 respectively and the supporting surface 39 supports other lower side corner portion of the inspection object 1.

And, in various embodiments of the present invention, the turret body 70 is mounted to the device 100 at the fore end of the arm of the robot 7 with the mounting bracket 71.

In this state, in various embodiments of the present invention, the rotary table 13 of the jig unit 10 is rotated at 90 degree intervals to return to a home position.

In this case, the rotary table 13 may rotate round the rotation shaft 23 of the base frame 11 as the underside of the rotary table 13 is in rolling contact with the roller members 25 of the base frame 11.

In this case, in various embodiments of the present invention, the rotation angle may be restricted to the 90 degrees by the restriction roller 27 mounted to each of the corner portions of the rotary table 13, and the stopper 41 mounted to each of corner portions of the base frame 11.

In detail, upon rotating the rotary table 13, in a case the rotary table 13 is rotated at 90 degrees, the restriction roller 27 is coupled to the holding recess 53 in the restriction block 45 of the stopper 41.

In this case, the restriction block 45, supported by the fixed block 43 through the guide rods 55, moves backward overcoming the elastic force of the spring 49 due to interference with the restriction roller 25.

And, as the restriction roller 25 couples to the holding recess 53 in the restriction block 45, the restriction block 45 moves forward to an original position owing to the elastic force of the spring 49. In this case, the elastic force of the spring 49 may be adjusted by rotating the adjusting knob 51 to move the restriction block 45 forward/backward.

Eventually, in various embodiments of the present invention, in a case the rotary table 13 rotates, since the restriction roller 25 is held at the restriction block 45 of the stopper 41 as well as the elastic force is applying to the restriction block 45 from the spring 49, the rotation position of the restriction block may be restricted at the 90 degree intervals.

As described before, in a state the rotary table 13 having the inspection object 1 loaded on the jig frames 15 is rotated to a predetermined position according to an item of inspection of the inspection object 1, in various embodiments of the present invention, the turret body 70 is moved toward the processed portion (A portion to be inspected) of the inspection object 1 with the robot 7.

In this step, in various embodiments of the present invention, the turret body 70 is rotated at the fixed angle by driving the step motor 73 according to the processed portion of the inspection object 1 for putting one the vision head 81, 82, and 83 matched to the processed portion close to the processed portion.

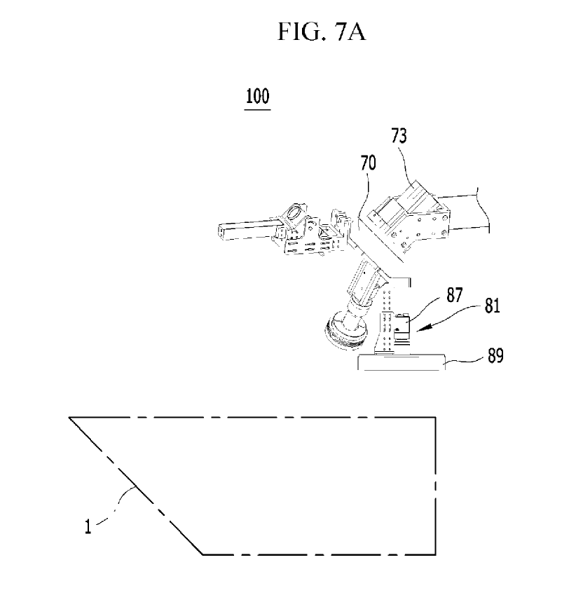

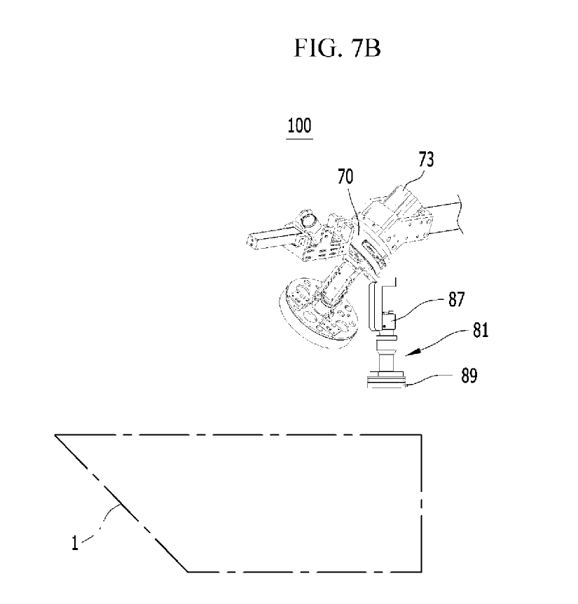

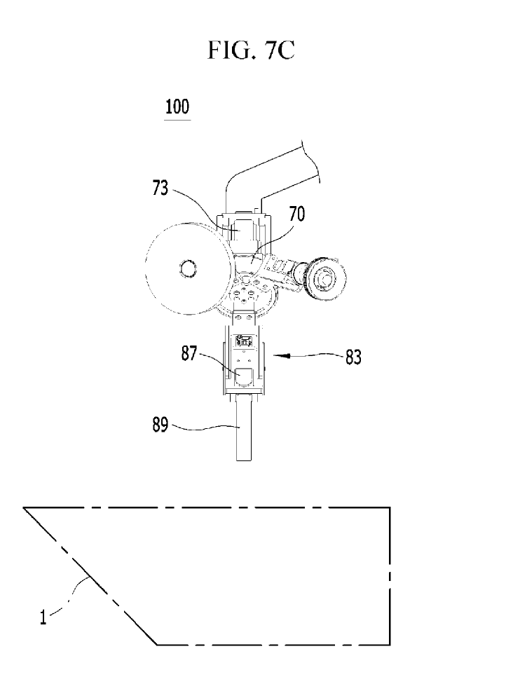

Then, referring to FIGS. 7 to 9, in various embodiments of the present invention, the inside/outside mounting surfaces (Processed surfaces), the inside surface of the hole, and the inside surface of the bore of the inspection object 1 may be vision photographed with respective vision heads 81, 82, and 83.

For an example, in various embodiments of the present invention, the inside/outside mounting surfaces of the inspection object 1 may be vision photographed with the first vision head 81 as shown in FIG. 7A, the inside surface of the hole of the inspection object 1 may be vision photographed with the second vision head 82 as shown in FIG. 7B, and the inside surface of the bore of the inspection object 1 may be vision photographed with the third vision head 83 as shown in FIG. 7C.

In this case, each of the vision heads 81, 82, and 83 may vision photographs the processed portion with the camera unit 87 in a state a light is directed to the processed portion (Portion to be inspected) of the inspection object 1 by using the lighting unit 89.

Upon vision photographing the processed portions of the inspection object 1 with the vision heads 81, 82, and 83, the vision data obtained by the vision heads 81, 82, and 83 are forwarded to the controller 90.

Then, the controller 90 stores the vision data temporarily, compares and analyzes the vision data with a reference data, extracts defect data of the processed portions of the inspection object 1, and determines whether the processed portion of the inspection object 1 is defective or not with reference to the defect data.

And, the controller 90 displays the defect data on the processed portion, and whether the processed portion is defective or not due to the defect data on the display means 95.

Eventually, in various embodiments of the present invention, quality defects of the processed portions of the inspection object 1, such as the three dimensional complicated shape of transmission case, may be subjected to total inspection, automatically.

Thus, the device 100 for quality inspection of an automotive part in accordance with various embodiments of the present invention, including the turret type multi-vision head having the turret body 70 rotated by the step motor 73, with the plurality of the vision heads 81, 82, and 83 radially mounted thereto, can inspect the inside/outside mounting surfaces (Processed surfaces), the inside surface of the hole, and an inside surface of the bore of the inspection object 1 with respective vision heads 81, 82, and 83 by rotating the turret body 70.

Eventually, in various embodiments of the present invention, since different processed portions of the inspection object 1 having a three dimensional complicated shape can be vision inspected automatically with the turret type multi-vision head by using one set of the robot 7, a number of robots required for quality inspection may be reduced, and robot automatic inspection of the inspection object 1 may be carried out even in a small space.

Thus, in various embodiments of the present invention, since the number of robots required for quality inspection may be reduced, robot automatic inspection of the inspection object 1 may be carried out even in a small space, an initial investment can be reduced, efficiency of the robot automatic inspection can be enhanced, and a cycle type of the quality inspection can be reduced.

For convenience in explanation and accurate definition in the appended claims, the terms upper or lower, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A device for quality inspection of an automotive part comprising:
a jig unit for securing and supporting an inspection object;
rotary vision imager mounted to a fore end of a robot arm rotatable in a turret type for vision photographing a plurality of processed portions of the inspection object; and
a controller for obtaining a vision data from the rotary vision imager, and analyzing and processing the vision data for extracting a defect of the processed portion.

2. The device of claim 1, wherein the rotary vision imager includes:
a circular turret body mounted to a fore end of the robot arm with a mounting bracket rotatable in both directions for a predetermined section by a step motor; and
a plurality of vision heads mounted to the turret body radially for vision photographing the processed portions of the inspection object.

3. The device of claim 1, wherein the vision heads vision photograph the inside/outside mounting surfaces, the inside surface of the hole, and the inside surface of the bore of the inspection object with the turret body rotated at a fixed angle by the step motor.

4. The device of claim 3, wherein the plurality vision heads mounted to the turret body spaced from one another at fixed angles include:
a first vision head for vision examination of the inside/outside mounting surfaces of the inspection object;
a second vision head for vision examination of the inside surface of the hole of the inspection object; and
a third vision head for vision examination of the inside surface of the inspection object.

5. The device of claim 4, wherein each of the vision heads includes:
a camera unit for vision photographing the processed portion of the inspection object; and
a lighting unit for directing light to an inspection portion.

6. The device of claim 1, wherein the jig unit includes:
a base frame;
a rotary table rotatably mounted to the base frame;
a plurality of jig frames mounted on the rotary table to stand upright;
fixing members mounted to some of the jig frames for securing the inspection object; and
supporting members mounted to a remainder of the jig frames for supporting the inspection object.

7. The device of claim 6, wherein
the base frame has a square shape matched to the rotary table, and a rotation shaft mounted at a central portion of the base frame for coupling to the rotary table; and
the base frame has a plurality of roller members mounted thereto radially rotatable centered on the rotation shaft.

8. The device of claim 6, wherein the base frame is a square shape matched to the rotary table;
the rotary table has a restriction roller rotatably mounted to each of corners of the rotary table; and
the base frame has a restriction stopper mounted to each of corner portions of the base frame matched to the restriction roller for supporting the restriction roller elastically and restricting a rotation position of the rotary table.

9. The device of claim 8, wherein the stopper includes:
a fixed block mounted fixedly secured to each of the corner portions of the base frame;
a restriction block having a holding recess for holding a roller surface of the restriction roller, the restriction block being movably mounted to the fixed block with one pair of guide rods passed through the fixed block;
a supporting block mounted to a passed through end portion of the guide rods; and
a spring disposed between the restriction block and the fixed block for applying elastic force to the restriction block.

10. The device of claim 9, wherein the supporting block has an adjusting knob screw coupled thereto for adjusting the elastic force of the spring.

11. The device of claim 6, wherein the fixing member includes:
a first securing pin mounted to the jig frame for coupling to a securing hole in the inspection object from a lower side to an upper side of the securing hole.

12. The device of claim 11, wherein the fixing member includes:
a second securing pin mounted to the jig frame for coupling to a securing hole in the inspection object from an upper side to a lower side of the securing hole.

13. The device of claim 12, wherein the second securing pin is provided to a securing bracket which may be secured to a top side portion of the jig frame for coupling to the securing hole passed through the top side portion.

14. The device of claim 6, wherein the supporting member is
mounted to the jig frame and includes a supporting pin for supporting an underside of the inspection object.

15. The device of claim 14, wherein the supporting member is
mounted to the jig frame and includes a supporting surface for supporting an underside of the inspection object.

16. The device of claim 6, wherein the jig unit further includes;
at least one hand grip member foldably mounted to an upper surface of the rotary table.

17. A device for quality inspection of an automotive part comprising:
a jig unit for securing and supporting an inspection object including a transmission case;
a circular turret body mounted to a fore end of a robot arm with a mounting bracket, the turret body being provided rotatable a predetermined section in both directions by a step motor;
a plurality of vision heads mounted to the turret body radially for vision photographing the processed portion of the inspection object; and
a controller for obtaining a vision data from the vision head and analyzing and processing the vision head for extracting a defect from the processed portion.

18. A method for quality inspection of an automotive part, in which processed portions of an inspection object including a transmission case is vision examined, comprising the steps of:
providing a device for quality inspection of an automotive part, the device including a jig unit for securing and supporting an inspection object including a transmission case, a circular turret body mounted to a fore end of a robot arm with a mounting bracket, the turret body being provided rotatable a predetermined section in both directions by a step motor, a plurality of vision heads mounted to the turret body radially for vision photographing the processed portion of the inspection object, and a controller for obtaining a vision data from the vision head and analyzing and processing the vision head for extracting a defect from the processed portion;
setting the inspection object to the jig unit, and mounting a turret body to a fore end of a robot arm;
driving a step motor to rotate the turret body, and moving one of a plurality of vision heads toward an inside/outside processed portion of the inspection object;
photographing the processed portion with the vision head and forwarding a vision data photographed thus to a controller; and
analyzing and processing the vision data with the controller for extracting defect data on the processed portion.

19. The method of claim 18, further comprising the steps of:
rotating a rotary table of the jig unit at 90 degree intervals;
rotating the vision heads at fixed angles with the turret body; and
vision examining inside/outside mounting surfaces, an inside surface of a hole, and an inside surface of a bore of the inspection object.

20. The method of claim 19, wherein a rotation position of the rotary table is restricted by a stopper.
